(19) United States
(12) Patent Application Publication
(10) Pub. No.: US 2025/0294442 A1
(43) Pub. Date: Sep. 18, 2025

(54) USER EQUIPMENT SUPPORT FOR PROVISION OF EDGE SERVICES WITH SESSION CONTINUITY DURING MOBILITY

(71) Applicant: Nokia Technologies Oy, Espoo (FI)

(72) Inventors: Swaminathan ARUNACHALAM, Dallas, TX (US); Devaki CHANDRAMOULI, Dallas, TX (US); Shubhranshu SINGH, Munich (DE); Laurent THIÉBAUT, Massy (FR)

(21) Appl. No.: 18/713,989

(22) PCT Filed: Nov. 29, 2021
(86) PCT No.: PCT/US2021/060968

§ 371 Date: May 28, 2024

(51) Int. Cl. H04W 48/20; H04W 28/08; H04W 48/16; H04W 88/04; H04W 92/18

(52) U.S. Cl. CPC H04W 48/20; H04W 28/0875; H04W 48/16; H04W 88/04; H04W 92/18

(57) ABSTRACT

Systems, methods, apparatuses, and computer program products for sidelink edge services with session continuity during mobility are provided. For example, a method can include method may include identifying, at a remote user equipment, offloading capability or edge service hosting capability of a user equipment. The method may also include selecting, by the remote user equipment, the user equipment to be used as a relay between the remote user equipment and a network element based on the identified offloading or service hosting capability.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for providing edge services with session continuity during mobility.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus can include at least one processor and at least one memory comprising computer program code. The at least one memory and computer program code can be configured, with the at least one processor, to cause the apparatus at least to perform identifying offloading capability or edge service hosting capability of a user equipment. The at least one memory and computer program code can also be configured, with the at least one processor, to cause the apparatus at least to perform selecting the user equipment to be used as a relay between the apparatus and a network based on the identified offloading or service hosting capability.

An embodiment may be directed to an apparatus. The apparatus can include at least one processor and at least one memory comprising computer program code. The at least one memory and computer program code can be configured, with the at least one processor, to cause the apparatus at least to perform establishing or modifying a session between a network and the apparatus. The session may be for relaying traffic from a user equipment to the network. The session may also be for or support locally offloading traffic from the user equipment.

An embodiment may be directed to an apparatus. The apparatus can include at least one processor and at least one memory comprising computer program code. The at least one memory and computer program code can be configured, with the at least one processor, to cause the apparatus at least to perform receiving a request for an offloading capability service provision. The at least one memory and computer program code can be configured, with the at least one processor, to cause the apparatus at least to perform providing a response based on an allowability of the offloading capability service.

An embodiment may be directed to a method. The method may include identifying, at a remote user equipment, offloading capability or edge service hosting capability of a user equipment. The method may also include selecting, by the remote user equipment, the user equipment to be used as a relay between the remote user equipment and a network element based on the identified offloading or service hosting capability.

An embodiment may be directed to a method. The method may include establishing or modifying, by a relay user equipment, a session between a network and the relay user equipment. The session may be for relaying traffic from a user equipment to the network. The session may also be for or support locally offloading traffic from the user equipment.

An embodiment may be directed to a method. The method may include receiving, at a network element, a request for an offloading capability service provision. The method may also include providing, by the network element, a response based on an allowability of the offloading capability service.

An embodiment may be directed to an apparatus. The apparatus may include means for identifying offloading capability or edge service hosting capability of a user equipment. The apparatus may also include means for selecting the user equipment to be used as a relay between the apparatus and a network based on the identified offloading or service hosting capability.

An embodiment may be directed to an apparatus. The apparatus may include means for establishing or modifying a session between a network and the apparatus. The session may be for relaying traffic from a user equipment to the network. The session may also be for or support locally offloading traffic from the user equipment.

An embodiment may be directed to an apparatus. The apparatus may include means for receiving a request for an offloading capability service provision. The apparatus may also include means for providing a response based on an allowability of the offloading capability service.

### BRIEF DESCRIPTION OF THE DRAWINGS

For proper understanding of example embodiments, reference should be made to the accompanying drawings, wherein:

FIG. 1 illustrates an overview of a system according to certain embodiments;

FIG. 2 illustrates session continuity during mobility, according to certain embodiments;

FIG. 3 illustrates a first part of a user equipment requested protocol data unit session establishment, according to certain embodiments;

FIG. 4 illustrates a second part of a user equipment requested protocol data unit session establishment, according to certain embodiments;

FIG. 5 illustrates a proximity-based services user equipment to network relay connection establishment, according to certain embodiments;

FIG. 6 illustrates a network relay discovery with a first model, according to certain embodiments;

FIG. 7 illustrates a network relay discovery with a second model, according to certain embodiments;

FIG. 8 illustrates session continuity during relay UE relocation, according to certain embodiments;

FIG. 9 illustrates an example flow diagram of a method, according to an embodiment;

FIG. 10 illustrates an example flow diagram of a method, according to an embodiment;

FIG. 11 illustrates an example flow diagram of a method, according to an embodiment;

FIG. 12A illustrates an example block diagram of an apparatus, according to an embodiment; and

FIG. 12B illustrates an example block diagram of an apparatus, according to an embodiment.

### DETAILED DESCRIPTION:

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing edge services with session continuity during mobility, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

In fifth generation (5G) new radio (NR) sidelink there can be communication using the PC5 interface even when there is no next generation radio access network (NG-RAN) coverage or partial next generation radio access network coverage. The PC5 interface can refer to an interface for direct short-range sidelink communication, which may not rely on passing messages through a base station or other access point. The PC5 interface may operate independently of a cellular network in contrast to the use of the Uu interface, which can by the air interface between a user equipment and other devices operating in, for example, a traditional broadband license spectrum, and transmitting messages through a base station, next generation Node B (gNB) or the like. In 5G NR sidelink, a lead user equipment (UE) may provide edge services to other UEs, which can be referred to as remote UEs, which are in proximity to the lead UE. The edge services may be provided using device to device (D2D)/proximity services (ProSE) communication.

There can be at least two use cases. In a first use case, many interactive services can happen in a local area. Thus, to provide cloud services, edge services, or a combination thereof, throughput, latency, reliability and resource/power utilization could be enhanced with the ProSe Communication path, directly between ProSe UEs or with the 5GC path between users. In case of an edge server that is hosted at the radio cloud or internet cloud, NR coverage outages may prevent service to users; moreover, a very low latency may be needed to provide a low latency service offering.

In a second use case, a first user equipment can act as a content cache for a second user equipment. Here, one or both user equipment devices may lose their connection to a base station, for example, if the Uu is disconnected.

Certain embodiments may provide a traffic offload point at a UE that is acting as a local breakout towards local applications running on the UE. Also, certain embodiments may provide session continuity for the offloaded traffic in a mobility scenario in which local breakout service is moving to another UE.

Certain embodiments may permit a UE to function as an edge service provider in a NR sidelink over PC5. Furthermore, certain embodiments may provide an option of 5G core controlled traffic offload in the lead UE, which can also be considered a relay UE. Moreover, certain embodiments can permit an option to handle session continuity of the offloaded traffic when the remote UE moves from one relay UE to another relay UE. Thus, certain embodiments may relate to offloading application workloads to other UEs in a NR sidelink over PC5.

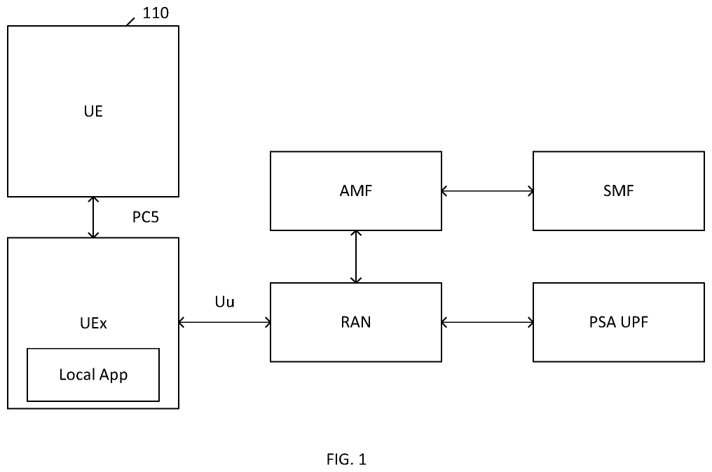

FIG. 1 illustrates an overview of a system according to certain embodiments. As shown in FIG. 1, a UE 110 may be a remote UE. UEx, acting as UE-to-network relay between UE 110 and RAN, can provide service with offload capability that is controlled by a session management function (SMF).

The remote UE, UE 110, can identify whether any relay UE has the offload capability, for example whether an edge service is or can be hosted on any relay UE. This identification can be performed through sending a PC5 discovery message and announcement message. The UE 110 can then select a relay UE, in this case UEx, to consume the edge service.

The relay UE, in this example UEx, can declare the relay UE's own edge service and offload capability with the SMF as part of a protocol data unit (PDU) session establishment procedure. The SMF can manage the establishment of the PDU session with branching point at the Relay UE (UEx).

When a remote UE (in this example, UE 110) initiates service use, a lead UE (in this case UEx) can start acting as a UE-to-network relay to establish the connection either by modifying an existing PDU session or initiating a new PDU session to cater the service.

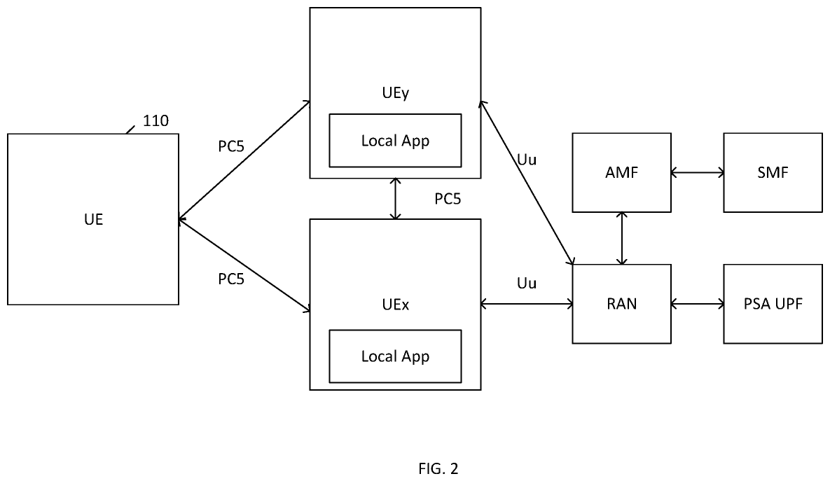

FIG. 2 illustrates session continuity during mobility, according to certain embodiments. Certain embodiments may address data integrity and forwarding to support session continuity during mobility.

To support UE mobility scenarios or for other purposes, various mechanisms can be provided. As shown in FIG. 2, a UE 110 may initially be connected to UEx. However, for various reasons it may be necessary or appropriate for UE to engage in relay UE relocation, such as relocation from UEx to UEy. In this case, a there may be a temporary tunnel establishment between UEx and UEy for the session continuity of the service(s). Data forwarding of, for example, edge application service traffic can be performed from UEx to UEy. After an end marker of the relocation, edge application service can continue from UEy via the RAN rather than via the PC5 temporary tunnel between UEx and UEy.

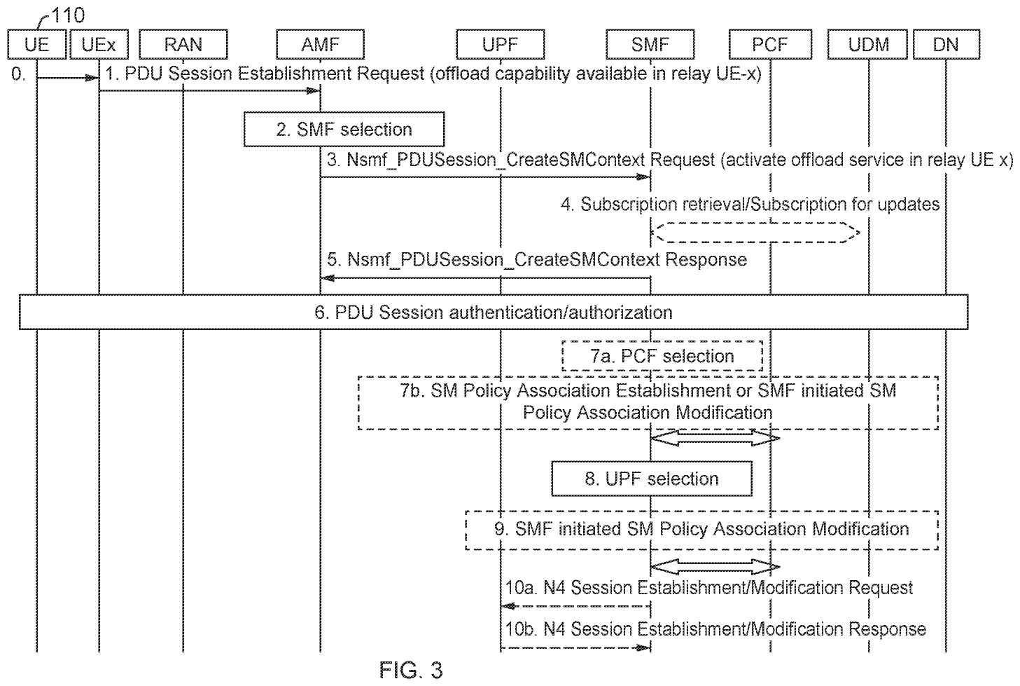

FIG. 3 illustrates a first part of a user equipment requested protocol data unit session establishment, according to certain embodiments. FIG. 3 may be applicable to a case where edge service is to be hosted by a relay UE. In this example, there can be a request regarding creation of an offload point that can flow from the relay UE to the access and mobility management function (AMF) and onward to the session management function (SMF). In this example, as in the previous examples, the remote UE is designated as UE 110, while UEx depicts the lead/relay UE.

At 0, the UE can select UEx to use the edge service upon discovering UEx using discovery procedures. At 1, the UEx can know that for the selected service traffic offload is needed, so during the PDU session establishment UEx can provide access to services and traffic offload capability to SMF. At 2, SMF selection can occur, for example, following 3GPP TS 23.502 V17.1.0 Clause 4.3.2.2. At 3, a parameter can be provided in a Request message to the SMF to notify the offload capability. This same parameter or a parameter conveying the same information can be used at 1 in the message from the UEx to the AMF. The procedures at 4, 5, 6, 7a, 7b, 8, 9, 10a, and 10b, may process a PDU session establishment as in 3GPP TS 23.502 V17.1.0 Clause 4.3.2.2.

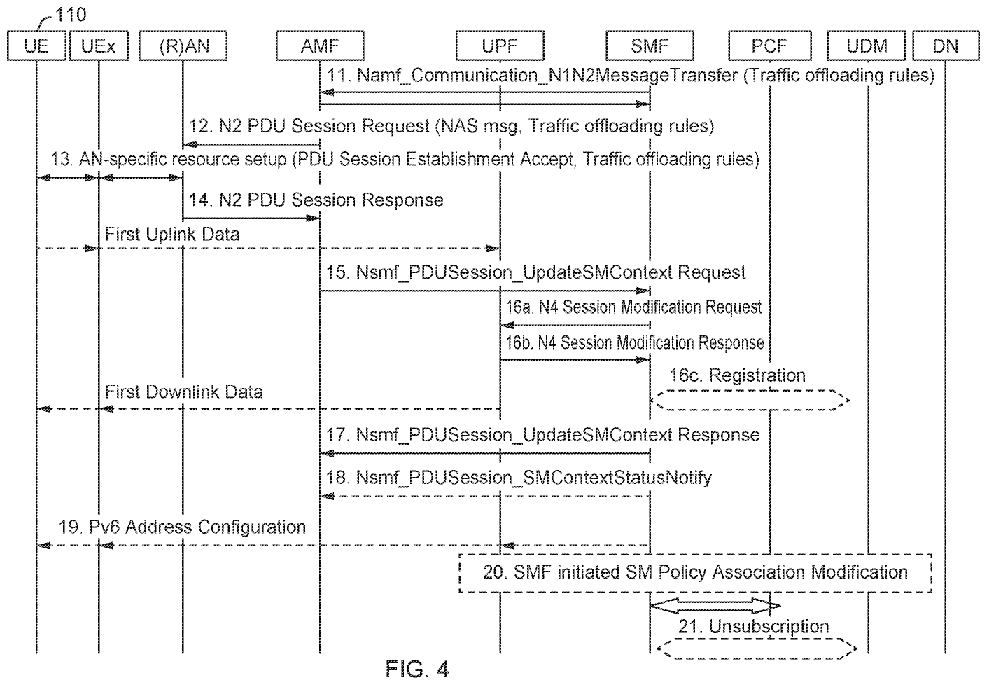

FIG. 4 illustrates a second part of a user equipment requested protocol data unit session establishment, according to certain embodiments. The procedures in FIG. 4 can begin where the processes in FIG. 3 left off.

At 11, after checking the policies from the policy control function (PCF), if the desired session establishment is allowed, SMF can inform the UEx with the traffic offloading rules as part of a PDU session establishment accept message. The traffic offloading rules sent by the SMF may indicate the IP address range that the UEx can use for the local services it is hosting.

In addition, once the PDU Session has been established, the SMF can send a PDU session update towards UE with updated with traffic offloading rules whenever such rules need to change.

At 12, the AMF can forward the PDU session establishment accept message containing the traffic offloading rules through an N2 PDU session resource request from SMF to the RAN. At 13, the RAN can forward the PDU session establishment accept message containing traffic offloading rules through an AN-specific signaling to UEx. The remainder of procedures 14, 15, 16a, 16b, 16c, 17, 18, and 19 can proceed as described in 3GPP TS 23.502 V17.1.0 Clause 4.3.2.2.

The UEx may now be able to offer user plane (UP) offload capability for the UE even when there is no coverage available to UE, which may also save over the air resources. At a subsequent time at 20, there can be an SMF initiated SM policy association modification, leading to unsubscription at 21.

The UEx may use the addressing information received from SMF in the PDU session establishment accept message containing traffic offloading rules to associate the local services it hosts with one of such addresses. Then the UEx can intercept DNS requests (sent by UE 110) that target a service it is hosting, and answer to UE 110 with one of such addresses.

Certain embodiments may apply to the case of UEx being a regular smartphone serving another smartphone UE 110. An example may be that both UEx and UE 110 belong to the same Public Safety team. Certain embodiments can also be used when the UEx is a specific UE deployed for the proper functioning of the network where the UEx may, for example, correspond to an integrated access and backhaul (IAB) as defined in 3GPP TS 38.300, where the IAB contains a UE that allows the IAB to exchange over the air traffic with the rest of the gNB. Another example of a use case is that of UEx being hosted in a regenerative satellite, where the traffic/service offloading/content delivery allowed by UEx to serve UE 110 allows saving satellite radio resources: access to the local content/services hosted by UEx may require only a single satellite hop, where actual access to content/services on the terrestrial network would require 2 hops. The illustrative examples given here are not limiting but just indicate potential usage of certain embodiments.

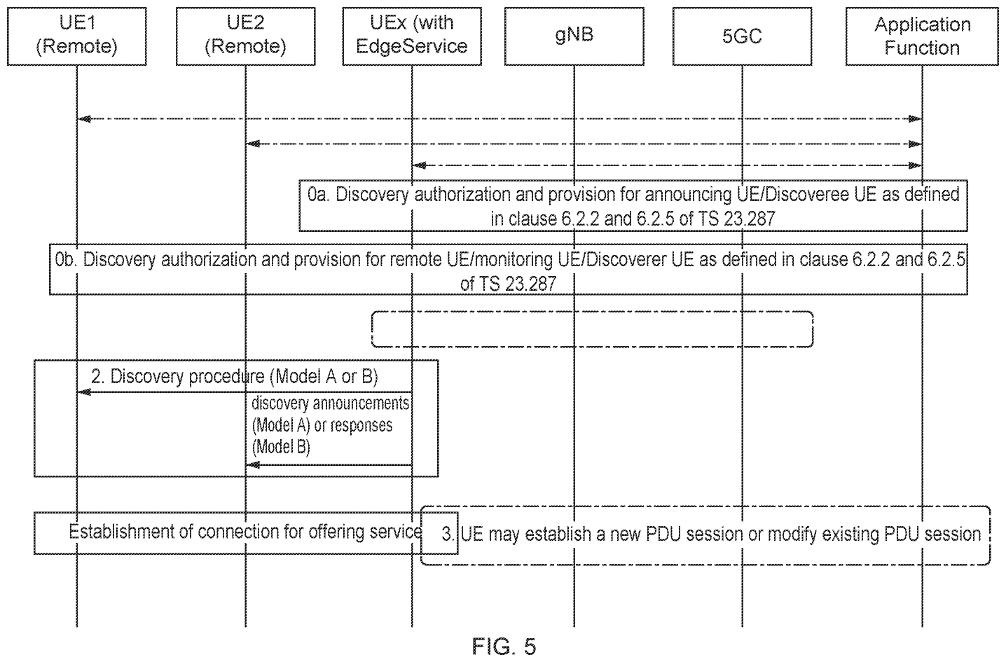

FIG. 5 illustrates a Proximity based or ProSe UE-to-network connection establishment, according to certain embodiments. As shown in FIG. 5, discovery of a relay UE's edge service capability can be performed by remote UEs. UE1 and UE2 depict remote UEs, while UEx depicts a lead/relay UE.

Discovery authorization and discover procedures can rely on parameter values to pass the capabilities like edge service and UE-to-UE tunneling. Message 0a in FIG. 5 can include parameters in the announce message, such as edge service and UE-to-UE tunneling capability by Relay UE (UE-x). In other respects, the message may be as defined in 3GPP TS 23.287, clauses 6.2.2 and 6.2.5. Similarly, the discovery authorization and related tasks may be performed at 0b otherwise as defined in 3GPP TS 23.287, clauses 6.2.2 and 6.2.5.

At message 2, remote UE2 can interpret the capability in the announce message and perform selection of relay UE. A similar approach can occur at UE1.

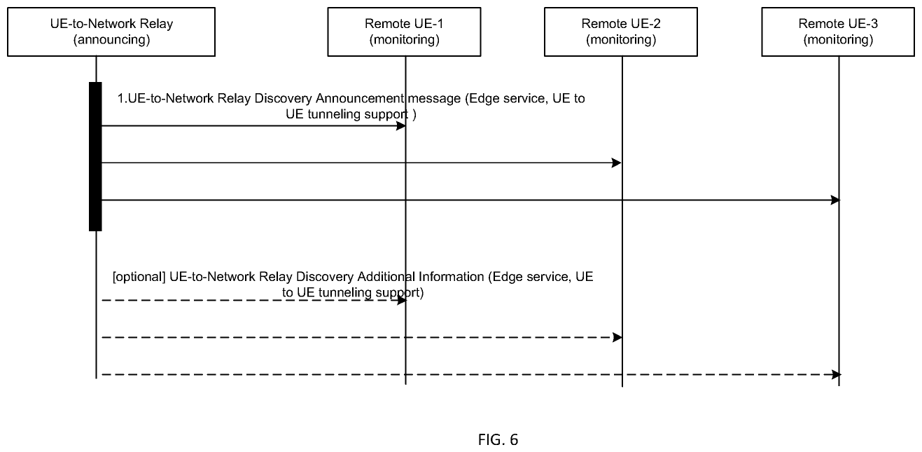

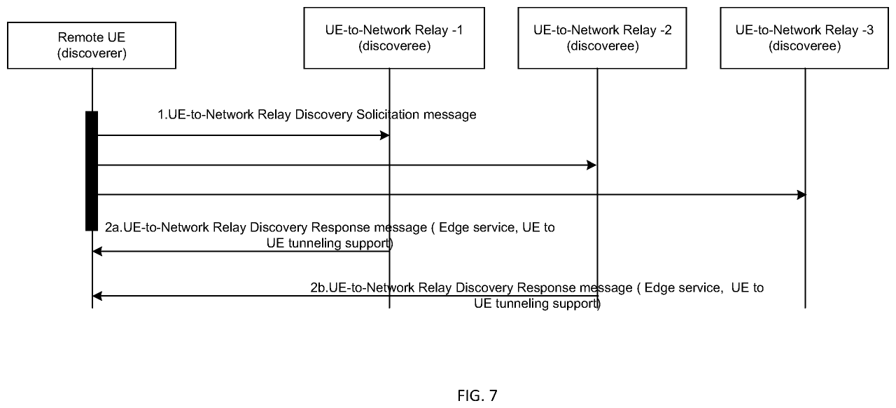

3GPP TS 23.304 v1.0.0 specifies two models: model A and model B for discovery of a UE-to-network Relay. FIGS. 6 and 7 illustrate an example of enhancements to those UE-to-Network Relay discovery methods based on model A and model B, respectively. Thus, FIG. 6 illustrates a network relay discovery with a first model, namely model A, according to certain embodiments, while FIG. 7 illustrates a network relay discovery with a second model, namely model B, according to certain embodiments.

As shown in FIG. 6, at 1 there can be a UE-to-network relay discovery announcement message. Remote UEs, shown as UE-1, UE-2, and UE-3, can each receive this message. Moreover, some or all of the details of the support for UE-to-network relay can optionally be sent in a later message, shown as a UE-to-network relay discovery additional information message.

As shown in FIG. 7, by contrast, at 1 a remote UE can send a UE-to-network discovery solicitation message to potential relay UEs, identified as UE-to-Network Relay-1, -2, and -3. At 2a, if the potential relay UE supports provision of edge service and/or UE-to-UE tunneling, the relay UE can respond with a UE-to-network discovery response message, which may indicate such support.

Thus, in FIG. 6, a UE-to-network relay can periodically broadcast messages that can include one or more of an indication whether the UE supports Edge services or an indication of UE-to-UE tunneling capabilities. As an alternative, the approach of FIG. 7 can avoid such broadcast messages from the relay UEs, but instead can rely on a solicitation message that can be sent when a remote UE has need for a relay UE.

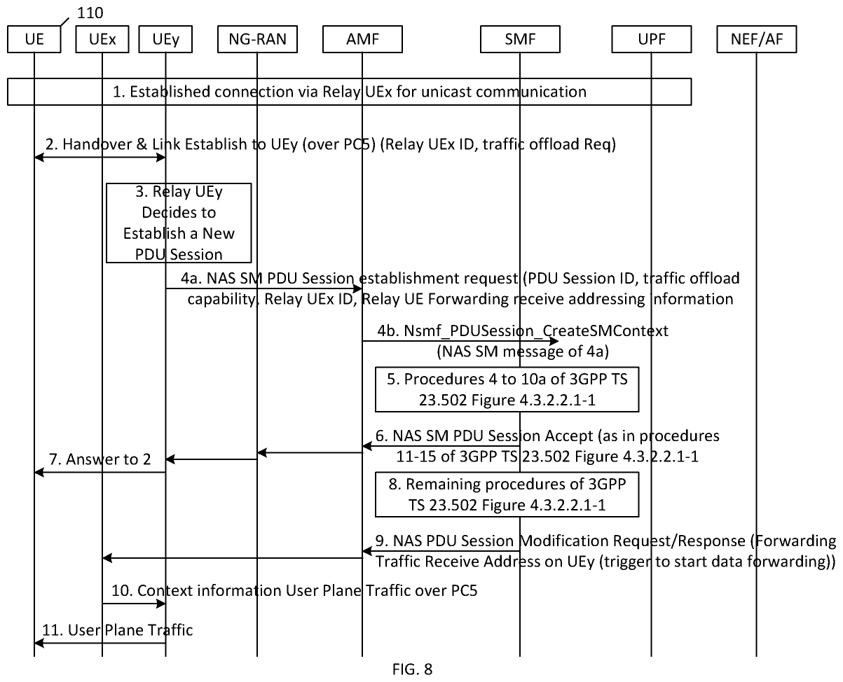

FIG. 8 illustrates session continuity during relay UE relocation, according to certain embodiments. FIG. 8 shows a possible message flow during session continuity for application relocation in a mobility scenario. UEx in FIG. 8 can depict the source relay-UE and UEy can depict the target relay-UE. The source and target designations may be due to UE mobility or due to changing radio conditions among UE, UEx, and UEy. The flow assumes that Ux and UEy are served by the same SMF set, thereby allowing the SMF of FIG. 8 to exchange NAS SM with both UEx and UEy.

The procedure as shown in FIG. 8 may enable application context to move from UEx to UEy, while remaining data traffic can be forwarded to UE via UEy. UEx and UEy can create temporary tunneling to allow UEx to forward UP traffic towards UEy to deliver the traffic between UE and UEy (e.g. via PC5 or via Uu and the network if both Uex and UEy cannot establish a PC5 link). When all the stored and/or incoming UP traffic in UEx buffer has been forwarded to Uy, UEx can also send an end marker to UEy giving an indication that the UP traffic forwarding is complete. UEy can now start delivering the traffic in case received over Uu towards the UE.

More particularly, at 1 the UE can have an established connection via Relay UEx, for example established as shown in FIGS. 3 and 4. At 2, as part of handover procedure to UEy, the UE 110 can indicate traffic offload request to UEy and can furthermore provide UEx ID (as an indication of the previous UE that was offering relay with traffic offload) to UEy. UE ID x can actually be an identifier received as part of traffic relay and offload via UEx, an identifier that allows the network (SMF) to retrieve the SUPI of the UEx as well as the PDU Session ID of the PDU Session of UEx that was carrying traffic for UE 110.

At 4, UEy can establish a new PDU Session for relaying. This establishment can be carried by a NAS SM PDU Session establishment that contains an indication to activate offload service in relay UEy as in procedure 3 of FIG. 3 but also the UEx ID as received in procedure 2 and the Relay UE Forwarding receive addressing information which indicates where UEx should send contextual information as well as remaining traffic UEx would wish to forward to UEy. At procedures 5 and 6, the SMF can determine the SUPI of the UEx and the PDU Session Id used by UEx to carry traffic of UE 110 (this can be used at procedure 9) and then the PDU Session establishment can proceed per procedures 4 to 10a of 3GPP TS 23.502 FIG. 4.3.2.2.1-1 (procedure 5) and per procedures 11-15 of 3GPP TS 23.502 FIG. 4.3.2.2.1-1 (procedure 6).

As UEy has now a PDU Session to carry the traffic of UE 110, UEy can at procedure 7 answer the relaying request received at procedure 2. In parallel, the PDU Session establishment can complete (procedure 8) with the remaining procedures of 3GPP TS 23.502 FIG. 4.3.2.2.1-1.

As UEy is ready for relaying and receiving context and data information from UEx, the SMF can (procedure 9) send a session modification request to UEx, triggering UEx to send any necessary context and data traffic to UEy. The request at procedure 9 can contain Relay UE Forwarding receive addressing information (received in procedures 4a/4b) which can indicate where UEx should send contextual information as well as remaining traffic UEx would wish to forward to UEy.

Finally, at 10 and 11, the UEx can send contextual information as well as remaining user plane traffic to UEy.

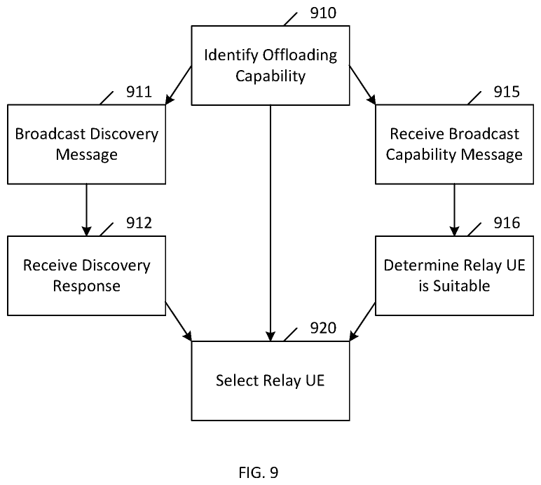

FIG. 9 illustrates an example flow diagram of a method for providing edge services with session continuity during mobility, according to certain embodiments.

The method can include, at 910, identifying, at a remote user equipment, offloading capability or edge service hosting capability of a user equipment. The method can also include, at 920, selecting, by the remote user equipment, the user equipment to be used as a relay between the remote user equipment and a network element based on the identified offloading or service hosting capability.

In some embodiments, the identifying can include, at 911, broadcasting, by the remote user equipment, a discovery message. The identifying can further include, at 912, receiving, by the remote user equipment, a discovery response to the discovery message from the user equipment.

The discovery response can indicate at least one of an ability to host an edge service or an ability to perform user equipment to network forwarding or user equipment to user equipment forwarding. Tunneling can be an example of forwarding for user equipment to network forwarding or user equipment to user equipment.

In some embodiments, the identifying can include, at 915, receiving, by the remote user equipment, a broadcast capability message from the user equipment. The identifying can also include, at 916, determining, by the remote user equipment, that the user equipment is suitable for selection based on the broadcast capability message.

The broadcast capability message indicates at least one of an ability to host an edge service or an ability to perform user equipment to user equipment tunneling or user equipment to network tunneling.

It is noted that FIG. 9 is provided as one example embodiment of a method or process. However, certain embodiments are not limited to this example, and further examples are possible as discussed elsewhere herein.

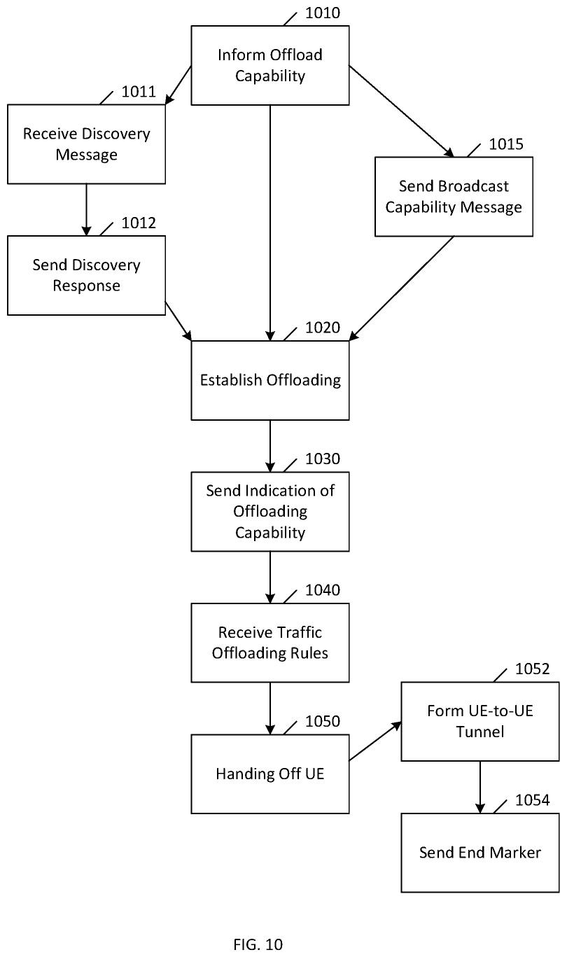

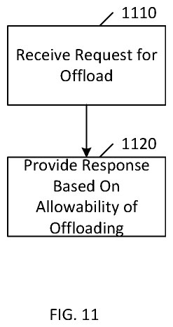

FIG. 10 illustrates an example flow diagram of a method for providing edge services with session continuity during mobility, according to certain embodiments. The method of FIG. 10 can be used alone or in combination with the methods of FIGS. 9 and 11.

The method can include, at 1010, informing, by a relay user equipment, an offloading capability to a user equipment. The method may also include, at 1020, establishing, by the relay user equipment, offloading to the user equipment responsive to the informed offloading or service offering capability. For example, the establishing at 1020 may broadly include establishing or modifying, by the relay user equipment, a session between the network and the relay user equipment. The session can be for relaying traffic from a user equipment to the network. The session can also be for or support locally offloading traffic from the user equipment.

The informing the offloading capability can include indicating at least one of an ability to provide an edge service or an ability to perform user equipment to user equipment tunneling or user equipment to network tunneling. In this example, the relay UE may function to host services, for example, cached data, and/or to forward incoming downlink traffic, for example, traffic from other devices, such as an application server.

The method can also include, at 1011, receiving, by the relay user equipment, a discovery message from the user equipment. The method can further include, at 1012, sending, by the relay user equipment, a discovery response to the discovery message. The discovery response can inform the offloading capability to the user equipment.

The informing can include, at 1015, sending a broadcast capability message from the user equipment. The broadcast capability message can indicate the offloading capability.

The establishing offloading can include establishing the session between the network and the user equipment, as mentioned above. The establishing can include, at 1030, sending an indication of offloading capability to the network. The establishing can further include, 1040, receiving traffic offloading rules from the network. Forwarding rules, for example, tunneling rules, can also be received from the network. The traffic offloading rules can include rules applicable to the user equipment. The traffic offloading rules and tunneling rules can be received together with the tunneling rules. The tunneling rules may be of use in the case of handing off. In the receiving at least one of tunneling rules or traffic offloading rules from the network, the traffic offloading rules can indicate an internet protocol (IP) address range that the apparatus can use for the local services the apparatus is hosting.

The method can further include, at 1050, handing off, by the relay user equipment, the user equipment to a further relay user equipment. The handing off can include, at 1052, forming a user equipment-to-user equipment tunnel with the remote user equipment and transferring at least one of context information or user plane data (for example, context information and/or user plane data) from the apparatus to the remote user equipment with the tunnel. The handing off can further comprises including an end marker when all user plane data is transferred to the remote user equipment.

It is noted that FIG. 10 is provided as one example embodiment of a method or process. However, certain embodiments are not limited to this example, and further examples are possible as discussed elsewhere herein.

FIG. 11 illustrates an example flow diagram of a method for providing edge services with session continuity during mobility, according to certain embodiments.

The method can include, at 1110, receiving, at a network element, a request for an offloading capability service provision. The method may also include, at 1120, providing, by the network element, a response based on an allowability of the offloading capability service. The providing the response can include providing tunneling information and/or traffic offloading rules.

It is noted that FIG. 11 is provided as one example embodiment of a method or process. However, certain embodiments are not limited to this example, and further examples are possible as discussed elsewhere herein.

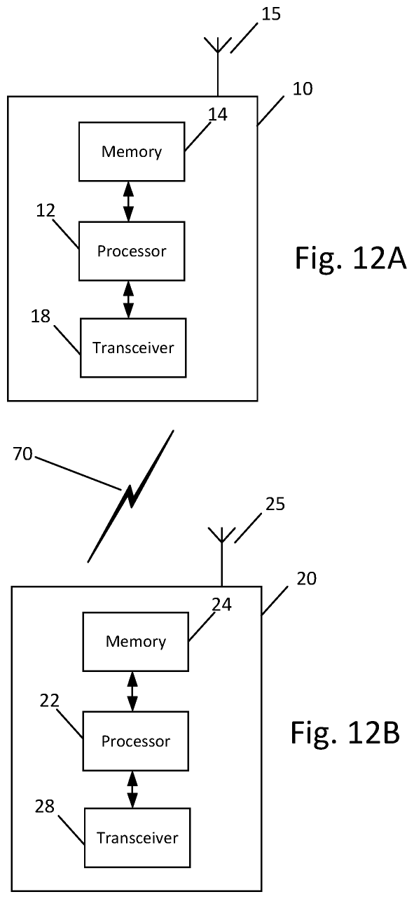

FIG. 12A illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 12A.

As illustrated in the example of FIG. 12A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 12A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-11, or any other method described herein. In some embodiments, as discussed herein, apparatus 10 may be configured to perform a procedure relating to providing edge services with session continuity during mobility, for example.

FIG. 12B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 12B.

As illustrated in the example of FIG. 12B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 12B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-11, or any other method described herein. For example, in an embodiment, apparatus 20 may be controlled to perform a process relating to providing edge services with session continuity during mobility, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, the mechanism of certain embodiments may permit passing of Group SyncRef UE role among member UEs by providing a consistent interpretation of Group SyncRef UE determination at every DRX cycle (or at fixed number of DRX cycles) across all member UEs. This may ensure fair/equal power saving at all member SL DRX UEs in supporting power efficient SL sync search at a SL DRX UE group. Hence, the SL DRX UE group can reap the benefit of having a group-specific SyncRef UE for reduced SL sync search to save power, without putting any member UE at disadvantage in terms of power consumption. Making the same member UE always perform potentially power-hungry full SL sync search may be considered putting that UE at a disadvantage in terms of power consumption. This balancing mechanism may be particularly beneficial for the power-constrained devices such as VRUs and for UEs in public safety and commercial use cases where the power saving is a critical requirement.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

App Application
CN Core Network
RAN Radio Access Network
SMF Session management Function as defined in 3GPP TS 23.501
UPF User Plane Function as definted in 3GPP TS 23.501

1. A user equipment, comprising:
at least one processor; and
at least one memory including computer program instructions which, when executed by the at least one processor, cause the user equipment at least to perform:
identifying one or more other user equipment comprising an offloading capability or an edge service hosting capability; and
selecting one other user equipment of the one or more other user equipment to be used as a relay between the user equipment and a network.

2. The user equipment of claim 1, wherein the identifying comprises:
broadcasting, via a sidelink of the user equipment, a discovery message to discover the one or more other user equipment comprising the offloading capability or the edge hosting capability; and
receiving a discovery response to the discovery message from the one other user equipment, the discovery response comprising an indication that the one other user equipment comprises the offloading capability or the edge service hosting capability.

3. (canceled)

4. The user equipment of claim 1, wherein the identifying comprises:
receiving a respective broadcast message from each respective other user equipment of the one or more other user equipment, wherein each respective broadcast message comprises an indication that the respective other user equipment comprises the offloading capability or the edge service hosting capability; and
determining that the each respective other user equipment is suitable for selection as the one other user equipment based on the indication in the respective broadcast message.

5. The user equipment of claim 1, wherein the edge service hosting capability comprises an ability of the user equipment to host an edge service and the offloading capability of the user equipment comprises an ability to perform user equipment to network forwarding.

6. A user equipment, comprising:
at least one processor; and
at least one memory including computer program instructions which, when executed by the at least one processor, cause the user equipment at least to perform:
sending, to a network, a request to establish or modify a session between a network and the user equipment, wherein the session is for relaying traffic received from another user equipment to the network, wherein the user equipment comprises an offloading capability.

7. The user equipment of claim 6, wherein the instructions, when executed by the at least one processor, further cause the user equipment to perform:
sending, to the network, an indication that the user equipment comprises of the offloading capability.

8. The user equipment of claim 7, wherein the instructions, when executed by the at least one processor, further cause the user equipment to perform: receiving, from the network, at least one of forwarding rules or traffic offloading rules, wherein the traffic offloading rules comprise rules applicable to traffic received from the another user equipment.

9. The user equipment of claim 8, wherein the traffic offloading rules indicate an internet protocol address range that the user equipment is permitted to use for edge services the user equipment is hosting.

10. The user equipment of claim 9, wherein the instructions, when executed by the at least one processor, further cause the user equipment to perform:
informing the another user equipment of the offloading capability of the user equipment; and
receiving traffic from the another user equipment; and
relaying traffic received from the another user equipment to the network over the session.

11. The user equipment of claim 10, wherein the offloading capability of the user equipment comprises ability to perform user equipment to network forwarding.

12. The user equipment of claim 11, wherein the instructions, when executed by the at least one processor, cause the user equipment at least to perform:
receiving, from the another user equipment, a discovery message to discover one or more user equipment that comprise the offloading capability; and
sending a discovery response to the discovery message, wherein the discovery response comprises an indication the user equipment comprises the offloading capability.

13. The user equipment of claim 10, wherein the informing comprises sending a broadcast message to the another user equipment, wherein the broadcast message comprises an indication that the user equipment comprises the offloading capability.

14-16. (canceled)

17. An apparatus, comprising:
at least one processor; and
at least one memory including computer program instructions, which when executed by the at least one processor, cause the apparatus at least to perform:
receiving a request for an offloading capability service; and
providing a response to the request based on an allowability of the offloading capability service.

18. The apparatus of claim 17, wherein the response to the request comprises at least one of tunneling rules or traffic offloading rules.

19-54. (canceled)
